(19) United States
(12) Patent Application Publication
(10) Pub. No.: US 2010/0272391 A1
(43) Pub. Date: Oct. 28, 2010

(54) CHROMATIC DISPERSION COMPENSATOR

(75) Inventors: Miki Onaka, Kawasaki (JP); Yukiko Sakai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/759,137

(22) Filed: Apr. 13, 2010

(30) Foreign Application Priority Data
Apr. 23, 2009 (JP) 2009-105075

(51) Int. Cl. G02B 6/34

(52) U.S. Cl. 385/27

(57) ABSTRACT

There is provided a chromatic dispersion compensator, which includes an optical circulator optically coupled to an input port and an output port, a chromatic dispersion compensation unit; including, and a light excitation source for supplying, to a light waveguide, excitation light. The chromatic dispersion compensation unit includes a light waveguide doped with the rare earth ion, a grating unit including a grating formed in at least a part of the longitudinal direction of the light waveguide, where the grating unit performing a chromatic dispersion compensation for a signal light input via the optical circulator to a one end of the light waveguide through the input port by reflecting the signal light flowing through the light waveguide according to a wavelength of the signal light and by returning the reflected signal light to the one end to lead to the output port via the optical circulator.

### CROSS-REFERENCE TO RELATED APPLICATION

This application is based upon and claims the benefit of priority of the prior Japanese Patent Application No. 2009-105075, filed on Apr. 23, 2009, the entire contents of which are incorporated herein by reference.

### FIELD

The present invention relates to a chromatic dispersion compensator for a signal light utilized in an optical communication at a low loss.

### BACKGROUND

With a recent increase in a communication traffic as a background, a construction of a photonic network allowing an ultra-high-speed large-capacity communication by using Wavelength Division Multiplexing (WDM) or Optical Time Division Multiplexing (TDM) has been progressed. An actual operation of a WDM optical transmission system based on a transmission speed at 40 Gb/s, for example, has recently started.

When the transmission speed of the signal light is equal to or larger than 40 Gb/s, an optical pulse width of the relevant signal light is as narrow as several pico seconds. For this reason, a waveform distortion due to a minute chromatic dispersion of an optical fiber significantly degrades a transmission characteristic of the signal light. Also, it is known that a chromatic dispersion value of the optical fiber varies over time along with an environment change such as a temperature, and the minute change affects the transmission characteristic.

With respect to the above-mentioned transmission characteristic degradation by the chromatic dispersion, an application of a chromatic dispersion compensation technology is effective. It is widely known that a chromatic dispersion compensation in a related art has a configuration in which a chromatic dispersion fiber is arranged on a transmission path, and a waveform distortion due to a chromatic dispersion of the transmission path is compensated by the chromatic dispersion fiber (for example, see Japanese Laid-open Patent Publication No. 2000-115077). In a case where a chromatic dispersion compensation for the WDM light is performed, in addition to an arrangement of the chromatic dispersion fiber on the transmission path, in a light receiving apparatus for receiving the WDM light propagating the transmission path by branching, it is effective to provide chromatic dispersion compensators on the respective light waveguides where the signal lights of a single wavelength after branching propagate. In the chromatic dispersion compensators on the respective light waveguides, a preferable chromatic dispersion compensation is performed in accordance with the wavelength of the branched signal light.

As the above-mentioned chromatic dispersion compensators, various configurations utilizing an optical device such as Fiber Bragg Grating (FBG), Etalon, and VIPA (Virtually Imaged Phased Array) are known. In such chromatic dispersion compensators, as a relatively large optical loss is generated, if a reception power of the signal light becomes small, Bit Error Rate (BER) abruptly increases. In order to suppress the increase in this BER, it is necessary to apply an optical amplifier on an input side or an output side of the chromatic dispersion compensator to compensate an insertion loss of the chromatic dispersion compensator.

FIG. 1 illustrates a configuration example in which the insertion loss for the chromatic dispersion compensator using the FBG in the related art may be compensated. In this configuration, a chromatic dispersion compensator 102 is connected between an input port IN and an output port OUT via an optical circulator 101. Also, on a light waveguide between the input port IN and the optical circulator 101, an optical amplifier 103A on the input side is provided. On a light waveguide between the optical circulator 101 and the output port OUT, an optical amplifier 103B on the output side is provided. A signal light provided to the input port IN is amplified by the optical amplifier 103A and then passes through the optical circulator 101 to be input to one end of the chromatic dispersion compensator 102. In the chromatic dispersion compensator 102, the signal light is reflected at different positions in accordance with the wavelengths to be returned to the optical circulator 101 side, so that the chromatic dispersion compensation for the relevant signal light is performed. The signal light output from the one end of the chromatic dispersion compensator 102 passes through the optical circulator 101 and is provided to the optical amplifier 103B on the output side. The signal light is amplified to a required optical power by the optical Amplifier 103B and is output from the output port OUT. Gains of the respective optical amplifiers 103A and 103B are controlled by control circuits (CONT) 105A and 105B on the basis of results of detections on the respective output light powers by monitors (MON) 104A and 104B. With such a configuration, the compensation for the insertion loss of the chromatic dispersion compensator 102 is performed by the optical amplifiers 103A and 103B on the input side and the output side.

### SUMMARY

According to an aspect of an embodiment, a chromatic dispersion compensator includes an optical circulator optically coupled to an input port and an output port; a chromatic dispersion compensation unit; and a light excitation source for supplying, to the light waveguide, excitation light. The chromatic dispersion compensator includes a light waveguide doped with a rare earth ion, a grating unit including a grating formed in at least a part of the longitudinal direction of the light waveguide, where the grating unit performs a chromatic dispersion compensation for a signal light input via the optical circulator to an one end of the light waveguide through the input port by reflecting the signal light flowing through the light waveguide according to a wavelength of the signal light and by returning the reflected signal light to the one end to lead to the output port via the optical circulator.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates a configuration example in which an insertion loss of a chromatic dispersion compensator may be compensated;

FIG. 2 illustrates a configuration of a chromatic dispersion compensator according to a first embodiment;

FIGS. 3A and 3B illustrate a configuration example of a chromatic dispersion compensation unit of an optical fiber type according to the first embodiment;

FIG. 4 illustrates a configuration example of a chromatic dispersion compensation unit of a light waveguide type according to the first embodiment;

FIG. 5 illustrates a preferable configuration example of an excitation unit according to the first embodiment;

FIGS. 6A and 6B are explanatory diagrams for describing a wavelength fixation of an excitation light according to the first embodiment;

FIGS. 7A and 7B illustrate each concretization of the configuration example of FIG. 5;

FIG. 8 is an explanatory diagram for describing a loss reduction effect of a signal light according to the first embodiment;

FIG. 9 illustrates a modified example related to the first embodiment;

FIG. 10 illustrates another modified example related to the first embodiment;

FIG. 11 illustrates a configuration in which the configurations in FIGS. 9 and 10 are combined;

FIG. 12 illustrates a further modified example related to the first embodiment;

FIG. 13 illustrates a configuration of a chromatic dispersion compensator according to a second embodiment;

FIG. 14 illustrates a configuration of a chromatic dispersion compensator according to a third embodiment;

FIG. 15 illustrates a modified example related to the third embodiment;

FIG. 16 illustrates another modified example related to the third embodiment;

FIG. 17 illustrates an example of a light receiving apparatus to which the chromatic dispersion compensator according to the above-mentioned embodiment is applied; and

FIG. 18 illustrates an example of a light relay apparatus to which the chromatic dispersion compensator according to the above-mentioned embodiment is applied.

### DESCRIPTION OF EMBODIMENTS

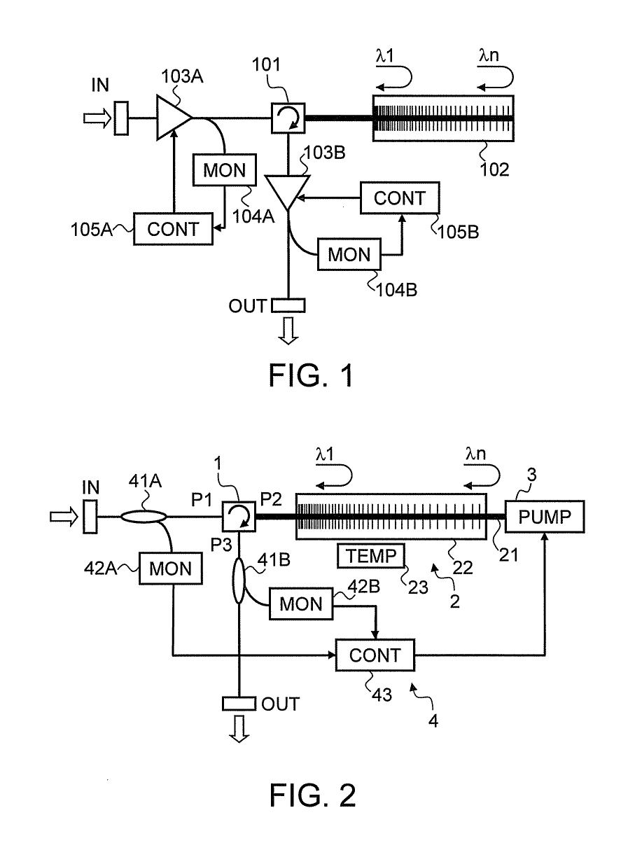

The configuration using the chromatic dispersion compensator and the optical amplifiers illustrated in FIG. 1 leads to an increase in the number of parts and an enlargement of the mounting area. Now the case is explain that the configuration described above is applied to a light receiving apparatus in which the chromatic dispersion compensators are provided on the respective light waveguides where the signal lights of the single wavelength after branching propagate. According to this, the mounting area which may be allocated to a receiving unit configuration corresponding to the respective wavelengths is constrained to the size of the entire apparatus in general. Accordingly, therefore it may be difficult to mount various functional parts including the chromatic dispersion compensator and the optical amplifiers into a predetermined space.

Also, even when the required functional parts may be mounted in the above-mentioned predetermined space, as the respective functional parts are tightly mounted, ventilation is degraded, and the temperature rises, which may exceed a permissible temperature set for the individual functional parts. Such a situation of course degrades a performance and a reliability of the light receiving apparatus, and also a problem in terms of thermal design occurs that the light receiving apparatus itself may not be designed.

Furthermore, the number of types of the functional parts mounted in the above-mentioned predetermined space is increased as the performance of the system is being enhanced, and therefore lack of the mounting space may make it difficult to deal with the higher performance in some cases. In particular, when it is necessary to take measures such as an increase in the number of the optical amplifiers or an expansion of the performance of the optical amplifiers close to the limit in order to compensate the insertion loss of the added functional parts, it is not simple to take such measures in a stable manner in the limited mounting space.

Entire mounting size of the light receiving apparatus is caused at a magnification ratio equal to the number of wavelengths of the WDM light. Accordingly, the mounting space for the receiving unit configuration corresponding to the respective wavelengths of the WDM light is expanded, even if the expansion amount of the space corresponding to the individual wavelengths is minute. Therefore, the size up will affect significantly the design of the light receiving apparatus. For this reason, the expansion of the mounting space is difficult to accept in the design of the light receiving apparatus where miniaturization is demanded.

Hereinafter, embodiments of the present invention will be described in detail with reference to the attached drawings. FIG. 2 illustrates a configuration of a chromatic dispersion compensator 4 according to a first embodiment. The chromatic dispersion compensator 4 includes a chromatic dispersion compensation unit 2 connected via an optical circulator 1 on a light waveguide between an input port IN and an output port OUT, an excitation unit (PUMP) 3 for supplying the chromatic dispersion compensation unit 2 with an excitation light, and a control unit 4 for controlling the excitation unit 3.

The optical circulator 1 has, for example, three ports in which a first port P1 is connected to the input port IN, a second port P2 is connected to a variable chromatic dispersion compensation unit 11, and a third port P3 is connected to the output port OUT. The optical circulator 1 has a characteristic for transmitting the light in one direction among the respective ports in which the light input to the first port P1 is output to the second port P2, and the light input to the second port P2 is output to the third port P3. It should be noted that by combining a general optical coupler and an optical isolator, it is also possible to realize a function similar to the optical circulator 1.

The chromatic dispersion compensation unit 2 is, for example, provided with a light waveguide 21 doped with the rare earth ion (a bold line part in FIG. 1), a grating unit 22 formed along the light waveguide 21, and a temperature adjustment circuit (TEMP) 23 functioning as a compensation amount variable unit for adjusting a temperature of the grating unit 22.

One end of the light waveguide 21 is connected to the second port P2 of the optical circulator 1, and the other end is connected to the excitation unit 3. The light waveguide 21 functions as a propagation path for the signal light for performing the chromatic dispersion compensation and also an optical amplification medium for amplifying the signal light. A mode of the light waveguide 21 may be any one of an optical fiber type in which a core part of the optical fiber is doped with the rare earth ion and a light waveguide type in which a light waveguide formed on a substrate is doped with the rare earth ion. A total length of the light waveguide 21 is previously set so that a gain with which at least an optical loss generated due to the grating unit 22 may be compensated is realized while receiving a supply of the excitation light from the excitation unit 3.

The grating unit 22 forms a grating along a part or an entirety in the longitudinal direction of the light waveguide 21 doped with the rare earth ion by periodically changing a refraction index of the relevant part and generates a Bragg diffraction to have a function of a reflection filter. The grating unit 22 generates a chromatic dispersion by gradually changing a pitch of the grating (Bragg diffraction) to change a return time of the reflection light in accordance with the wavelength. It should be noted that an operation principle and a characteristic of a chromatic dispersion compensator using a fiber grating are described in detail, for example, in A. Sakamoto, et al, “Dispersion Compensation Fiber Grating For Next Generation High Speed Communication”, Fujikura Technical Review, Volume 106, pp. 1-4, April 2004, and therefore a description will be omitted herein.

The temperature adjustment circuit 23 adjusts the temperature of the grating unit 22 on the basis of wavelength information of the signal light input to the input port IN. As the pitch of the grating is changed while the temperature of the grating unit 22 is changed by the temperature adjustment circuit 23, the chromatic dispersion compensation amount in the grating unit 22 is set variable. It should be noted that the example in which the variable chromatic dispersion compensation is realized through the temperature adjustment by the grating unit 22 has been shown herein. Instead of the temperature adjustment or in parallel with the temperature adjustment, by applying a stress to the light waveguide part where the grating is formed, the chromatic dispersion compensation amount may be changed.

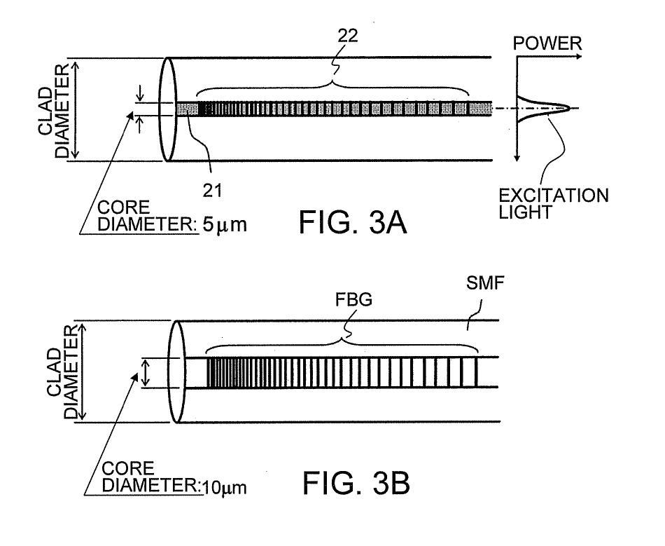

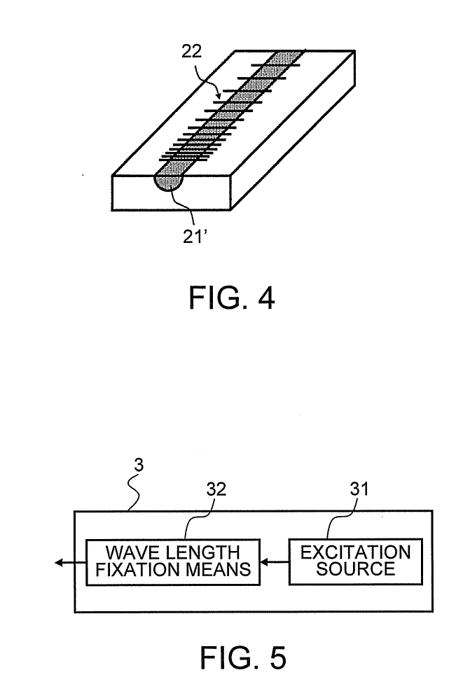

FIGS. 3A, 3B and 4 illustrate specific configurations of the light waveguide 21 and the grating unit 22. FIGS. 3A and 3B illustrate the configuration examples of the optical fiber type. FIG. 3A illustrates the light waveguide 21 and the grating unit 22 used in the chromatic dispersion compensation unit 2 according to the first embodiment, and FIG. 3B illustrates those corresponds to the chromatic dispersion compensation unit using the conventional FBG. In addition, FIG. 4 illustrates the configuration example of the light waveguide type.

As to the configuration example of the optical fiber type illustrates FIG. 3B, first, the configuration of the chromatic dispersion compensation unit using the FBG is generally obtained by utilizing a Single Mode Fiber (SMF) and forming a grating along a longitudinal direction of a core part thereof at a required pitch corresponding to the wavelength of the light signal which may be a target of the chromatic dispersion compensation. A core diameter of the SMF utilized for this chromatic dispersion compensator is normally 10

In contrast to this, the chromatic dispersion compensation unit 2 illustrated in FIG. 3A according to the present embodiment is designed to obtain a preferable optical amplification characteristic by using an optical fiber having a core diameter smaller than the above-mentioned core diameter of the SMF and doping the core part with the rare earth ion. To be more specific, for example, by using an optical fiber having a core diameter of about 5 μm which is approximately half of the core diameter of the SMF and doping the core part with erbium ion at a high density (for example, equal to or larger than 1,000 ppm), the core part may have a function as an optical amplification medium. A reason why the optical fiber having the small core diameter is that with respect to the rare earth ion doped in the center part of the optical fiber, the excitation light having a wavelength shorter than the signal light is efficiently overlapped. The right side diagram in FIG. 3A exemplifies an intensity distribution of the excitation light in a cross sectional direction of the optical fiber from which it is understood that the excitation light concentrates at the core part. According to this, the required gain may be realized by the short light waveguide length. Then, by forming the grating unit 22 at a required pitch corresponding to the wavelength of the light signal which may be the target of the chromatic dispersion compensation along the longitudinal direction of the core part doped with the above-mentioned rare earth ion, the chromatic dispersion compensation similar to the conventional chromatic dispersion compensator is realized. To elaborate, the chromatic dispersion compensation unit 2 illustrated in FIG. 3A has both the function as the optical amplification medium and the function as the chromatic dispersion compensator, and by realizing both the functions by the commonized configuration, the space saving is achieved.

The configuration example shown in FIG. 4 is the optical amplification medium obtained by utilizing a general light waveguide substrate and doping a light waveguide 21′ thereof with the rare earth ion. Then, by forming the grating unit 22 at a required pitch corresponding to the wavelength of the light signal which may be the target of the chromatic dispersion compensation along a longitudinal direction of the light waveguide 21′, the chromatic dispersion compensation function is realized. As to the optical amplification medium of the light waveguide type, optical quenching is hardly generated, and therefore it is possible to dope the rare earth ion at an even higher density. As the density of the rare earth ion is higher, the light waveguide path for realizing the required gain is shortened. Therefore, by applying the configuration of the light waveguide type, as compared with the configuration example of the above-mentioned optical fiber type, the chromatic dispersion compensation unit 2 with more advanced space saving may be realized.

The excitation unit 3 (FIG. 2) generates the excitation light having a wavelength allowing the rare earth ion doped in the light waveguide 21 of the chromatic dispersion compensation unit 2 to be excited and directly provides the relevant excitation light to the other end of the light waveguide 21 (the end part on the side opposite to the connection end with the optical circulation). As shown in FIG. 5, for example, the excitation unit 3 is preferably provided with an excitation source 31 and wavelength fixation means 32. The wavelength fixation means 32 is configured to fix a wavelength and a band width of the excitation light output from the excitation source 31 while corresponding to a periodically repeating transmission band of the chromatic dispersion compensation unit 2.

In general, the excitation source used for the excitation of the rare earth ion is a multiple mode oscillation, and a band width of the excitation light output from the excitation source is about 5 to 10 nm. This band width of the excitation light is wider than 1 nm which is supposed as the band width of the signal light. The chromatic dispersion compensation unit 2 adopts a resonator structure using the grating as described above and has a characteristic in which a transmission loss periodically changes with respect to the wavelength. With respect to the light input to the one end part of the chromatic dispersion compensation unit 2, the above-mentioned transmission loss represents how much the relevant light output from the other end part of the chromatic dispersion compensation unit 2 receives the loss. That is, when an input power of the light having a wavelength λ, input to the one end part of the chromatic dispersion compensation unit 2 is set as Pin(λ) and an output power of the relevant light output from the other end part of the chromatic dispersion compensation unit 2 is set as Pout(λ), the transmission loss of the chromatic dispersion compensation unit 2 is defined by Pin(λ)-Pout(λ). This transmission loss with respect to the light having the wavelength λ, of the chromatic dispersion compensation unit 2 is basically a value in accordance with the reflection rate with respect to the light having the wavelength 2 of the grating unit 22, and it may be considered that the transmission loss may be substituted by the reflection rate.

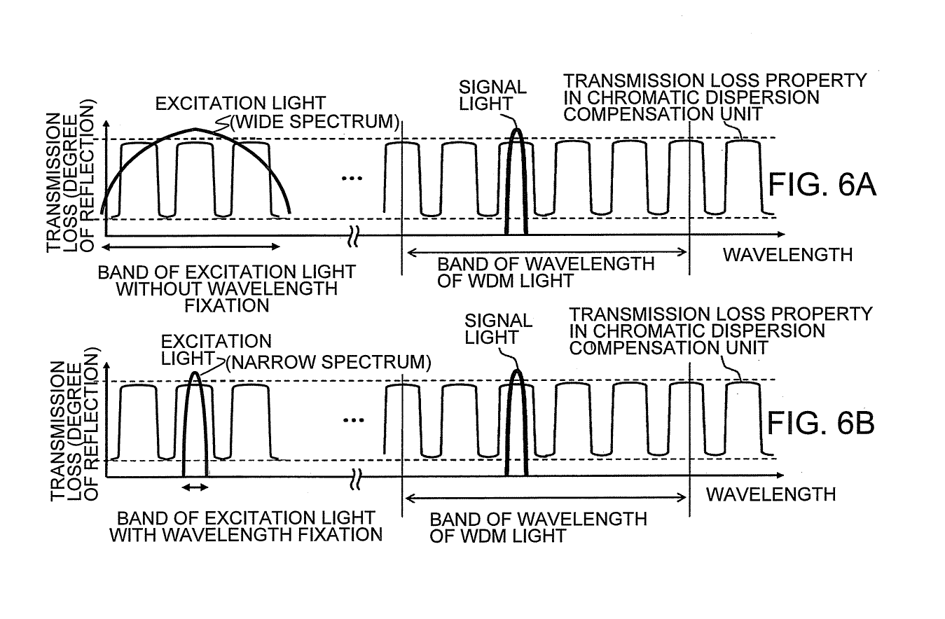

As described above, as the chromatic dispersion compensation unit 2 has the configuration in which the signal light is reflected in the mid-flow of the light waveguide 21, and the return time of the reflection light is varied in accordance with the wavelength to perform the chromatic dispersion compensation, the design is carried out so that a compensation band of the chromatic dispersion and a reflection spectrum of the grating unit 22 are set equivalent to each other. For this reason, a width of the periodically repeating reflection spectrum of the grating unit 22 is a narrow band width close to the spectrum width of the signal light 1 nm). This periodic reflection wavelength characteristic of the grating unit 22 continues not only in the vicinity of the wavelength band of the signal light but also in the vicinity of the wavelength band of the excitation light. Therefore, as illustrated in FIG. 6A, as to the excitation light having the wide spectrum width, a part of the spectrum component is reflected in the mid-flow of the light waveguide 21 due to the periodic reflection wavelength characteristic of the grating unit 22. To elaborate, the spectrum component of the excitation light in a band where the reflection rate of the grating unit 22 is large only propagates up to the mid-flow of the light waveguide 21, and therefore the energy of the excitation light contributing to the excitation of the rare earth ion is decreased. When the above-mentioned contents are paraphrased by the transmission loss of the chromatic dispersion compensation unit 2 described above, it is difficult for the spectrum component of the excitation light in a band where the transmission rate is large to transmit the light waveguide 21 from the one end to the other end, which leads to a reduction in the excitation efficiency.

In view of the above, the wavelength and the spectrum width of the excitation light output from the excitation source 31 are selected so as to be equal to or within a low loss band of the transmission property in chromatic dispersion compensation unit 2. Further in the preferable configuration example of the excitation unit 3, the wavelength of the excitation light is fixed by the wave length fixation means 32 in the excitation unit 3 as illustrated in FIG. 5. According to this, as illustrated in FIG. 6B, as the spectrum width of the excitation light is about the same as the spectrum width of the signal light and equivalent to the width of one transmission band of the chromatic dispersion compensation unit 2, the reduction of the excitation light energy on the light waveguide 21 of the chromatic dispersion compensation unit 2 is avoided or decreased. Thus, the rare earth ion doped in the light waveguide 21 may be efficiently excited.

It should be noted that in the optical amplifier using the general rare earth ion doped fiber, when the rare earth ion contributing to the light amplification forms an inverted distribution, as the width of the excitation level is wide, if the excitation light having a wide spectrum width is used, a preferable amplification characteristic may be obtained. For this reason, the necessity of narrowing the spectrum width of the excitation light to be equivalent to the spectrum width of the signal light does not occur in a normal use.

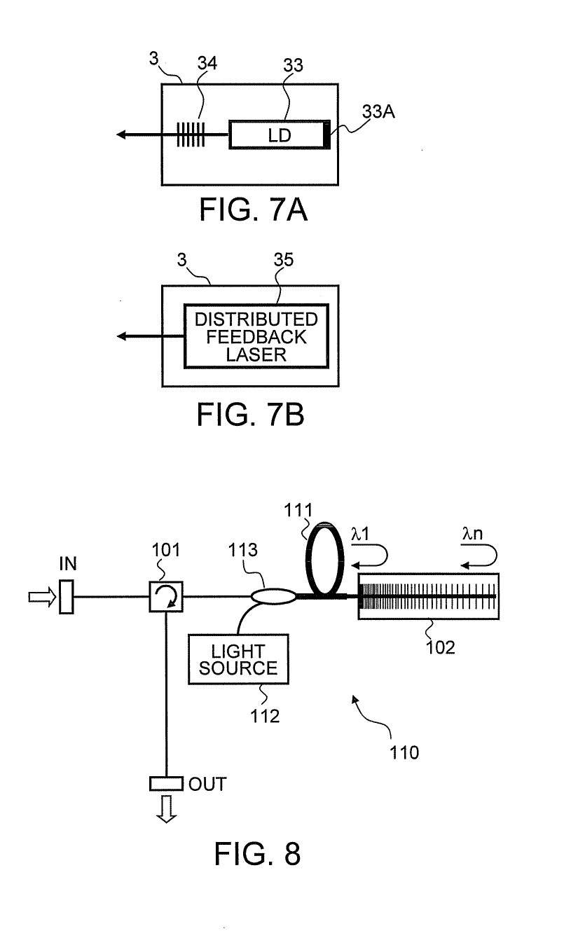

FIGS. 7A and 7B illustrate the configuration examples of the excitation unit 3 shown in FIG. 5 described above. In the specific example illustrated in FIG. 7A, for a fiber on an output side of a general excitation light source 33 (LD), a fiber grating 34 for reflecting a particular wavelength at a relatively low reflection rate is formed, and a resonator structure is adopted between the fiber grating 34 and a rear chip end surface 33A of the excitation light source 33. By setting a reflection wavelength of the fiber grating 34 to be matched with a center wavelength of at least one transmission band of the chromatic dispersion compensation unit 2, while following the principle of Fabry-Perot, the excitation light of the narrow band whose wavelength is fixed is output from the excitation unit 3. In addition, in the specific example illustrated in FIG. 7B, a distributed feedback laser 35 is applied as the excitation light source. The distributed feedback laser 35 is generally utilized as a light source of a signal light and may generate a light with a narrow spectrum width and a fixed wavelength.

The control unit 4 (FIG. 2) is, for example, provided with a splitter 41A and an input monitor (MON) 42A for monitoring the power of the signal light input from the input port IN via the optical circulator 1 to the chromatic dispersion compensation unit 2, a splitter 41B and an output monitor (MON) 42B for monitoring the power of the signal light output from the chromatic dispersion compensation unit 2 via the optical circulator 1 to the output port OUT, and a control circuit (CONT) 43 for controlling the excitation unit 3 on the basis of the respective monitor results of the input monitor 42A and the output monitor 42B. The control circuit 43 determines the output light power on the basis of the monitor result of the output monitor 42B and performs a feedback control on the power of the excitation light supplied from the excitation unit 3 to the chromatic dispersion compensation unit 2 so that the output light power becomes constant at a previously set level. In addition, the control circuit 43 determines an abnormality of the input light on the basis of the monitor result of the input monitor 42A and performs a shutdown control on the excitation unit 3 and the like.

Next, an operation according to the first embodiment will be described. In the chromatic dispersion compensator having the above-mentioned configuration, the signal light input to the input port IN passes through the first port P1 of the optical circulator 1 to the second port P2 to be provided to the one end of the light waveguide 21 doped with the rare earth ion of the chromatic dispersion compensation unit 2. It should be noted that the signal light to be input may be a signal light of a single wavelength or a WDM light including a plurality of signal lights where a wavelength arrangement is performed at a predetermined interval. A part of the signal light to be input is branched by the splitter 41A arranged between the input port IN and the optical circulator 1, the power of the relevant branched light is monitored at the input monitor 42A, and the monitor result is transmitted to the control circuit 43. In the control circuit 43, an input state of the signal light is determined on the basis of the monitor result of the input monitor 42A, and when no abnormality is generated, the excitation unit 3 is put into a drive state. The excitation light output from the excitation unit 3 is supplied from the end part on the opposite side to the input end of the signal light with respect to the light waveguide 21 of the chromatic dispersion compensation unit 2. According to this, the rare earth ion inside the light waveguide 21 is put into an excitation state. Also, in the temperature adjustment circuit 23 of the chromatic dispersion compensation unit 2, on the basis of wavelength information provided from the outside or the like, the chromatic dispersion compensation amount with respect to the signal light to be input is determined, and a temperature adjustment for the grating unit 22 is performed so as to realize the chromatic dispersion compensation amount.

The signal light input to the one end of the light waveguide 21 of the chromatic dispersion compensation unit 2 propagates in the light waveguide 21 while being amplified due to the induced emission of the excited rare earth ion, and when reaching the part where the grating unit 22 is formed, the propagation direction is inversed while being reflected at a position in accordance with the wavelength. This reflection light is also amplified due to the induced emission of the excited rare earth ion and propagates in the light waveguide 21 towards the optical circulator 1. As the signal light reciprocates within the chromatic dispersion compensation unit 2 to be returned to the second port P2 of the optical circulator 1, concurrently with conduct of the chromatic dispersion compensation for the relevant signal light, the optical loss generated due to the grating unit 22 is efficiently compensated by the light amplification over the approach route and the return route.

The signal light returned to the second port P2 of the optical circulator 1 passes through the third port P3 of the optical circulator 1 to be output to the outside from the output port OUT. At this time, a part of the signal light is branched by the splitter 41B arranged between the optical circulator 1 and the output port OUT, the power of the relevant branched light is monitored at the output monitor 42B, and the monitor result is transmitted to the control circuit 43. In the control circuit 43, the power of the signal light output from the output port OUT is determined on the basis of the monitor result of the output monitor 42B, and a feedback control is performed on the drive state of the excitation unit 3 so that the relevant output light power becomes constant at a previously set level. According to this, the signal light subjected to the chromatic dispersion compensation is output from the output port OUT to the outside at the constant power.

As described above, according to the chromatic dispersion compensator of the first embodiment, the grating unit 22 is formed along the light waveguide 21 doped with the rare earth ion, the excitation light is supplied to the light waveguide 21, and the chromatic dispersion compensation for the signal light and the compensation for the optical loss generated at that time are performed by the common chromatic dispersion compensation unit 2, so that it is possible to realize the efficient space saving. In addition to this, the formed light waveguide 21 of the grating unit 22 is constructed as the optical amplification medium, and therefore the excitation light output from the excitation unit 3 may be directly supplied to the light waveguide 21 where the signal light propagates without intermediation of an optical multiplexer or the like, so that the optical loss received by the signal light on the light waveguide 21 may be reduced.

The reduction effect of the optical loss will be described in detail with reference to FIG. 8. In the configuration exemplified in FIG. 8, by separately providing an optical fiber amplifier 110 between the chromatic dispersion compensator 102 using the FBG and the optical circulator 101 to the configuration illustrated in FIG. 1, it is supposed that the compensation for the insertion loss of the chromatic dispersion compensator 102 is performed. In other words while corresponding to the above-mentioned first embodiment, a configuration is supposed in which the formed light waveguide of the grating unit is not constructed as the optical amplification medium, and the function of the chromatic dispersion compensation and the function of the optical amplification (compensation for the insertion loss) are provided separately. In the configuration illustrated in FIG. 8, in order to supply an excitation light output from an excitation unit 112 to an optical amplification medium 111 of the optical fiber amplifier 110, it is necessary to insert an optical multiplexer 113 on the light waveguide between the optical circulator 101 and the chromatic dispersion compensator 102. The signal light input and output with respect to the chromatic dispersion compensator 102 passes through the optical multiplexer 113 and therefore receives the insertion loss of the optical multiplexer 113 over the approach route and the return route two times.

On the other hand, in the configuration according to the first embodiment (FIG. 2), the light waveguide 21 of the grating unit 22 is constructed as the optical amplification medium, and therefore the excitation light output from the excitation unit 3 may be directly supplied from the end part on the opposite side to the signal light input and output end of the light waveguide 21. To elaborate, it is not necessary to provide an optical multiplexer for supplying the excitation light on the propagation waveguide for the signal light. For this reason, as compared with the configuration of FIG. 8, the optical loss received by the signal light may be reduced, and it is possible to suppress SN degradation or NF degradation.

Also, according to the chromatic dispersion compensator of the first embodiment, the temperature adjustment for the grating unit 22 is performed by the temperature adjustment circuit 23 in order to vary the chromatic dispersion compensation amount, but also at the same time this contributes to suppression of the temperature change of the light waveguide 21 doped with the rare earth ion. As the gain obtained by the optical amplification medium doped with the rare earth ion fluctuates depending on the temperature of the light waveguide 21, the temperature of the light waveguide 21 is stabled by the temperature adjustment circuit 23, so that it is also possible to obtain an effect that the amplification characteristic of the signal light is improved.

Furthermore, if the wavelength and the spectrum width of the excitation light output from the excitation unit 3 are fixed while corresponding to the wavelength characteristic of the periodic transmission loss of the chromatic dispersion compensation unit 2, it is also possible to further increase the excitation efficiency. In addition, in a case where the configuration example of the light waveguide type is applied to the chromatic dispersion compensation unit 2, it is possible to dope the rare earth ion at a high density, the waveguide length necessary for realizing the required gain is shortened, and it is possible to realize further space saving.

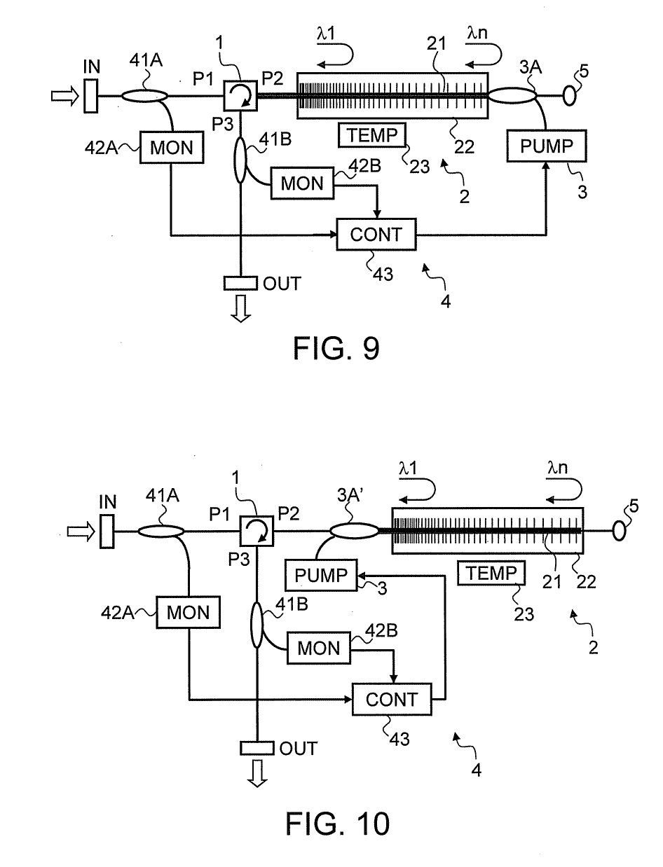

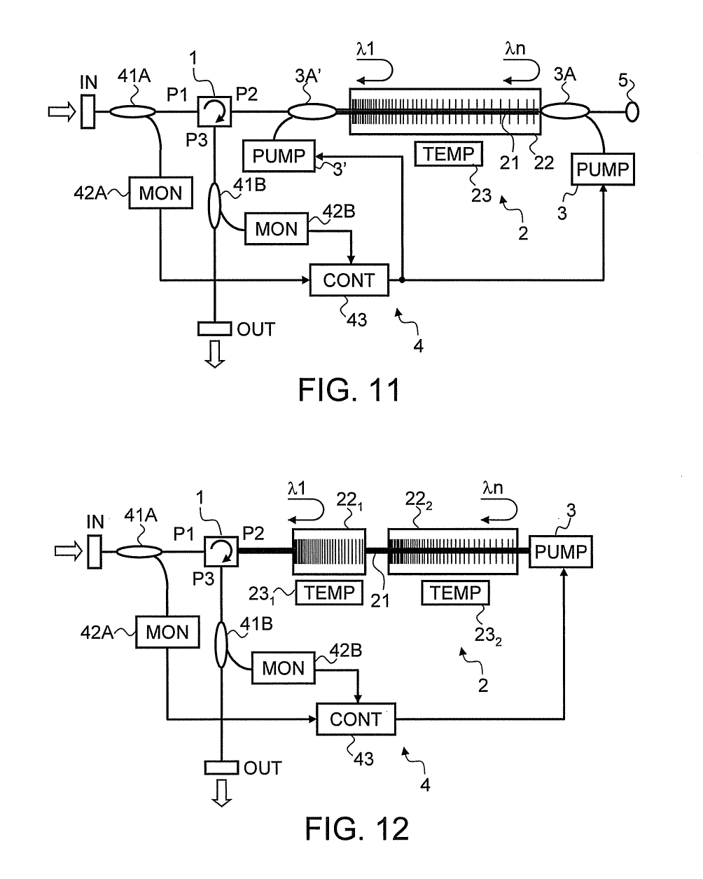

It should be noted that according to the first embodiment, the excitation light output from the excitation unit 3 is directly supplied to the light waveguide 21 of the chromatic dispersion compensation unit 2, but the supply method of the excitation light to the light waveguide doped the rare earth ion according to the present invention is not limited to the above. For example, as shown in FIG. 9, an optical multiplexer 3A is provided to the end part on the opposite side to the signal light input and output end of the light waveguide 21, and via the optical multiplexer 3A, the excitation light output from the excitation unit 3 may be supplied to the light waveguide 21. In this case, the signal light is reflected by the grating unit 22 to be returned to the optical circulator 1 side, and therefore the signal light does not receive an insertion loss of the optical multiplexer 3A. An optical terminal device 5 connected to the optical multiplexer 3A may also be omitted. Also, as shown in FIG. 10, an optical multiplexer 3A′ is provided to the signal light input and output end of the light waveguide 21, and via the optical multiplexer 3A′, the excitation light output from the excitation unit 3 may be supplied to the light waveguide 21. In this case, as the signal light passes through the optical multiplexer 3A′, the signal light receives an insertion loss of the optical multiplexer 3A′, and the signal light attenuates, but the other effects such as the space saving are basically similar to the case of the first embodiment. In the configuration of FIG. 10, as a residual excitation light may be emitted from the other end of the light waveguide 21, it is preferable to connect the optical terminal device 5 to the other end of the light waveguide 21. Furthermore, for example, as illustrated in FIG. 11, by combining FIGS. 9 and 10, the excitation light may of course be supplied from both ends of the light waveguide 21.

Also, the configuration has been described according to the above-mentioned first embodiment in which the grating unit 22 is formed along the light waveguide 21 which is doped with the rare earth ion at one location. However for example, as illustrated in FIG. 12, the grating unit may be separated and formed at a plurality of locations. The number of the grating units and the arrangement on the light waveguide 21 may be appropriately decided while taking into account the length of the light waveguide 21, ease of forming the grating, and the like. It should be noted that in an example of the drawing, temperature adjustment circuits 23₁ and 23₂ are separately provided while respectively corresponding to respective grating units 22₁ and 22₂, but the temperature adjustment for the respective grating units 221 and 222 may be performed by a common temperature adjustment circuit.

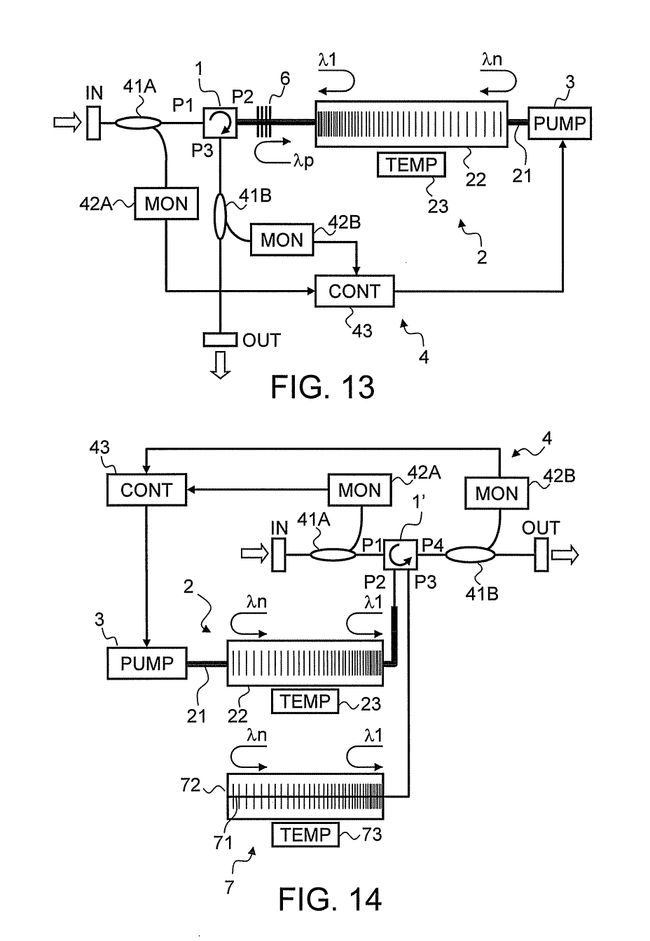

Next, a second embodiment of the present invention will be described. FIG. 13 illustrates a configuration of a chromatic dispersion compensator according to the second embodiment. In FIG. 13, in the chromatic dispersion compensator according to the present embodiment, an excitation light reflection unit 6 is added in the vicinity of the one end of the light waveguide 21 (connection end with the optical circulator) with regard to the configuration of the above-mentioned first embodiment shown in FIG. 2. The excitation light reflection unit 6 reflects the excitation light and is provided with a filter characteristic for transmitting the signal light. As a specific configuration of the excitation light reflection unit 6, for example, when a grating having a required pitch corresponding to a wavelength 2 of the excitation light is adopted, the excitation light reflection unit 6 may preferably be formed in the same step as the grating unit 22. It should be however noted that it does not mean the configuration of the excitation light reflection unit 6 is limited to the grating.

According to the chromatic dispersion compensator having the above-mentioned configuration, not only an action effect similar to the case of the above-mentioned first embodiment is obtained. Furthermore, the residual excitation light which does not contribute the excitation of the rare earth ion is reflected by the excitation light reflection unit 6 and reutilized, so that it is possible to further improve the excitation efficiency.

Next, a third embodiment of the present invention will be described. According to the above-mentioned first and second embodiments, the input and output of the signal light with respect to the chromatic dispersion compensation unit are performed by using the optical circulator having the three ports. According to the third embodiment, an applied example will be described in which while the light waveguide length is extended by increasing the number of ports of the optical circulator, the chromatic dispersion compensation with an even higher performance may be realized.

FIG. 14 illustrates a configuration of the chromatic dispersion compensator according to the third embodiment. In FIG. 14, the chromatic dispersion compensator according to the present embodiment uses an optical circulator 1′ having, for example, four ports in which an input port IN is connected to a first port P1 via a splitter 41A. Also, the chromatic dispersion compensation unit 2 similar to the first embodiment is connected to a second port P2, and a chromatic dispersion compensation unit 7 having no optical amplification function is connected to a third port P3. Furthermore, an output port OUT is connected to a fourth port P4 via a splitter 42B. It should be noted that herein the configuration example using the optical circulator having the four ports will be described, but an optical circulator having five or more ports may also be similarly applied.

In the light waveguide 21 doped with the rare earth ion of the chromatic dispersion compensation unit 2, similarly as in the first embodiment, the excitation light output from the excitation unit 3 is supplied, and the chromatic dispersion compensation for the signal light and the optical amplification are performed at the same time. Also, the constant control of the output light power by the control unit is also executed similarly as in the first embodiment.

The chromatic dispersion compensation unit 7 connected to the third port P3 of the optical circulator 1 is basically similar to the chromatic dispersion compensator 102 using the FBG illustrated in FIG. 1, and a grating unit 72 is formed along a longitudinal direction of a light waveguide 71 which is not doped with rare earth ion. Also, through a temperature adjustment for the grating unit 72 by a temperature adjustment circuit (TEMP) 73, the chromatic dispersion compensation is set variable.

In the chromatic dispersion compensator having the above-mentioned configuration, similarly as in the case of the first embodiment, the signal light input to the input port IN passes from the first port P1 of the optical circulator 1′ to the second port P2 to be provided to the chromatic dispersion compensation unit 2 and reciprocate in the light waveguide 21 of the chromatic dispersion compensation unit 2. The signal light output from the chromatic dispersion compensation unit 2 further passes from the second port P2 of the optical circulator 1′ to the third port P3 to be provided to the chromatic dispersion compensation unit 7 to reciprocate in the light waveguide 71 of the chromatic dispersion compensation unit 7. According to this, not only in the chromatic dispersion compensation unit 2, but also in the chromatic dispersion compensation unit 7, the chromatic dispersion compensation for the signal light is performed, so that it is possible to perform the chromatic dispersion compensation in an even wider range. Also, the insertion losses due to the grating units 22 and 72 of the respective chromatic dispersion compensation units 2 and 7 are compensated by the optical amplification in the light waveguide 21 doped with the rare earth ion of the chromatic dispersion compensation unit 2. Then, the signal light output from the chromatic dispersion compensation unit 7 passes from the third port P3 of the optical circulator 1′ to the fourth port P4 to be output from the output port OUT to the outside.

As described above, according to the chromatic dispersion compensator of the third embodiment, not only an action effect similar to the case of the first embodiment is obtained, but also the variable range of the chromatic dispersion compensation amount may be expanded while the light waveguide where the chromatic dispersion compensation for the signal light is performed is extended by using the optical circulator 1′ having the four ports, so that it is possible to improve the performance of the chromatic dispersion compensator.

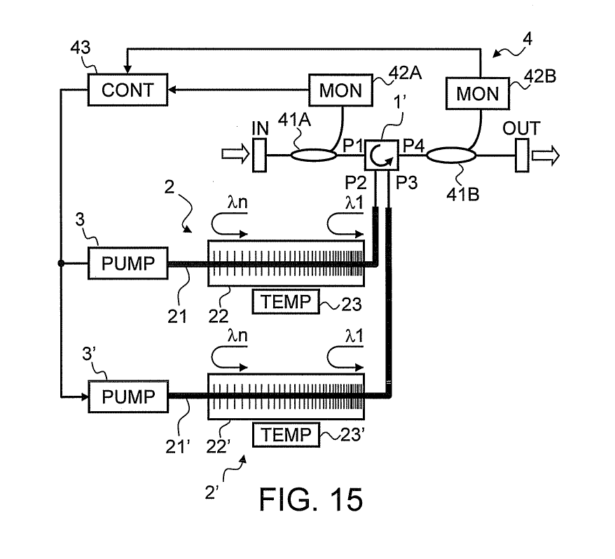

It should be noted that according to the above-mentioned third embodiment, the case has been described in which only one of the two chromatic dispersion compensation units has the optical amplification function, but for example, as shown in FIG. 15, the chromatic dispersion compensation units 2 and 2′ similar to the first embodiment may be connected to both the second port P2 and the third port P3 of the optical circulator 1′. In this case, the compensation for the insertion loss by the optical amplification is performed in the respective chromatic dispersion compensation units 2 and 2′. According to this, an even higher gain may be obtained by the chromatic dispersion compensator as a whole, and it is possible to expand the compensation range of the insertion loss.

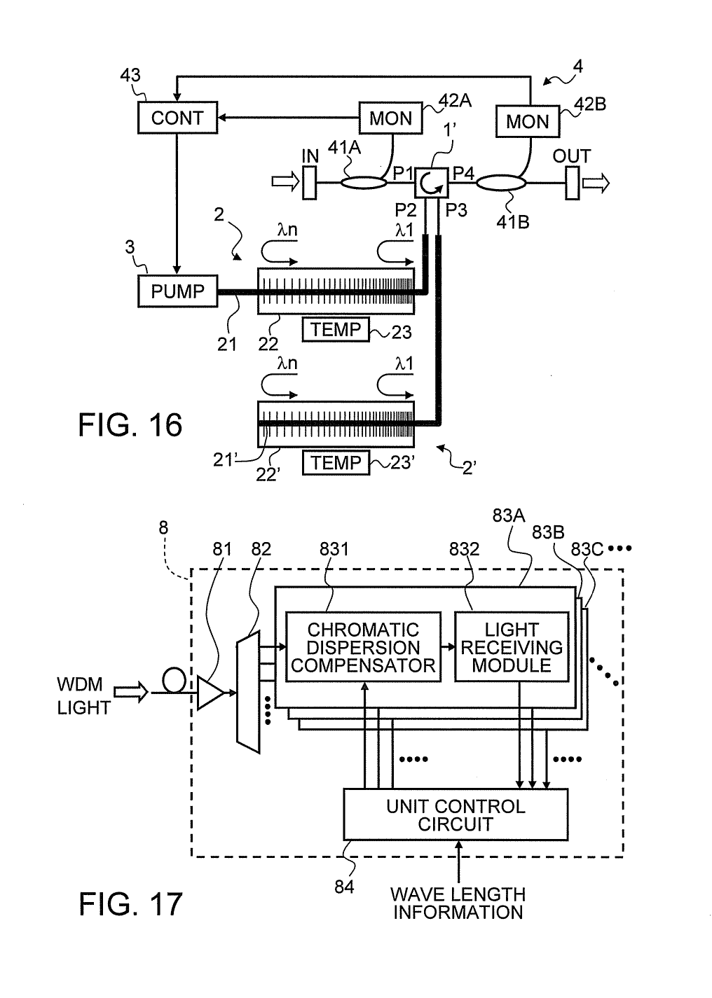

Furthermore, for example, as illustrated in FIG. 16, it is also possible to adopt an application of omitting an excitation unit 3′ for supplying the excitation light to the chromatic dispersion compensation unit 2′ in the latter stage in the configuration illustrated in FIG. 15. In the configuration of FIG. 16, the residual excitation light in the chromatic dispersion compensation unit 2 in the former stage passes through the optical circulator 1′ to be supplied to the chromatic dispersion compensation unit 2′. According to this, the optical amplitude width in the respective chromatic dispersion compensation units 2 and 2′ may be realized by the common excitation unit 3, and it is possible to achieve simplification of the configuration and space saving.

Next, embodiments of various apparatuses to which the chromatic dispersion compensator according to the above-mentioned first to third embodiments is applied will be described.

FIG. 17 illustrates an example of a light receiving apparatus used for a WDM optical transmission system. A light receiving apparatus 8 illustrated in FIG. 17 is provided with an optical preamplifier 81, a splitter 82, a plurality of light receiving units 83A, 83B, 83C . . . , and a unit control circuit 84. Also, the respective light receiving units 83A, 83B, 83C have a chromatic dispersion compensator 831 and a light receiving module 832 according to any one of the above-mentioned first to third embodiments.

In the optical preamplifier 81, the WDM light propagating in the transmission path is collectively amplified to a required level and output to the splitter 82. In the splitter 82, the WDM light from the optical preamplifier 81 is branched to signal lights having respective wavelengths, and the respective signal lights are output to the respective light receiving units 83A, 83B, 83C . . . . In the respective light receiving units 83A, 83B, 83C . . . , after the signal light from the splitter 82 is subjected to the chromatic dispersion compensation by the chromatic dispersion compensator 831, the signal light output from the chromatic dispersion compensator 831 at the required level is provided to the light receiving module 832 to perform a reproduction processing or the like on data. At this time, operations of the respective light receiving units 83A, 83B, 83C . . . are controlled by the unit control circuit 84 on the basis of wavelength information notified from the outside (such as the number of wavelengths of the WDM light received by the light receiving apparatus 8 or a use wavelength).

In the above-mentioned light receiving apparatus 8, the mounting spaces allocated to the respective light receiving units 83A, 83B, 83C . . . are restrained by the size of the whole apparatus, and as the number of wavelengths of the WDM light is larger, the mounting spaces corresponding to the respective wavelengths are narrower. However, as described above, the chromatic dispersion compensator 831 according to the respective embodiments is configured to have the optical amplification function, and also the space saving is achieved, so that the mounting to a limited space may be conducted. According to this, it is possible to provide the light receiving apparatus capable of reliably performing the reception processing for the ultra-high-speed signal light at 40 Gb/s or faster.

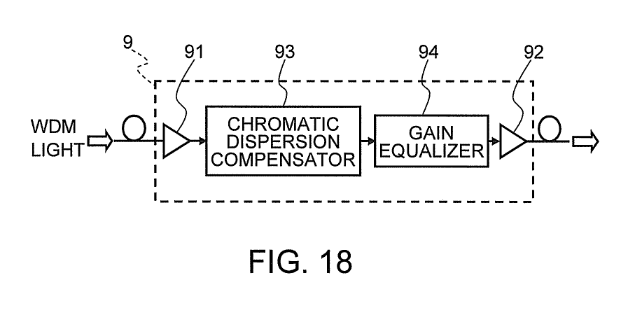

FIG. 18 illustrates an example of a light relay apparatus used for the WDM optical transmission system. A light relay apparatus 9 illustrated in FIG. 18 is provided with a chromatic dispersion compensator 93 and a gain equalizer 94 according to any one of the above-mentioned first to third embodiment between stages of WDM optical amplifiers 91 and 92 having a two-stage configuration.

In the light relay apparatus 9, the WDM light collectively amplified by the WDM optical amplifier 91 in the former stage is input to the chromatic dispersion compensator 93, and the chromatic dispersion compensation with respect to the signal lights of the respective wavelengths included in the WDM light is jointly performed in the chromatic dispersion compensator 93. The gain equalizer 94 cancels gain wavelength characteristics in the WDM optical amplifiers 91, 92 and the chromatic dispersion compensator 93 to reduce an inter-wavelength deviation of the WDM light power output from the light relay apparatus 9.

It should be noted that it is also possible to omit the gain equalizer 94. Also, in a case where the high accuracy chromatic dispersion compensation is performed for each signal light of the respective wavelengths in the reception end of the system, it suffices that the accuracy of the chromatic dispersion compensation in the light relay apparatus 9 may be relatively low, and therefore it is also possible to fix the chromatic dispersion compensation amounts with respect to the respective signal lights.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A chromatic dispersion compensator comprising:
an optical circulator optically coupled to an input port and an output port;
a chromatic dispersion compensation unit including:
a light waveguide doped with a rare earth ion;
a grating unit including a grating formed in at least a part of the longitudinal direction of the light waveguide, the grating unit performing a chromatic dispersion compensation for a signal light input via the optical circulator to an one end of the light waveguide through the input port by reflecting the signal light flowing through the light waveguide according to a wavelength of the signal light and by returning the reflected signal light to the one end to lead to the output port via the optical circulator; and
a light excitation source for supplying, to the light waveguide, excitation light

2. The chromatic dispersion compensator according to claim 1, further comprising a wavelength fixation configured to fix a wavelength and a band width of the excitation light output from the light excitation source corresponding to a periodically repeating transmission band determined in the chromatic dispersion compensation unit.

3. The chromatic dispersion compensator according to claim 1, wherein the light excitation source supplies the excitation light to the other end of the light waveguide.

4. The chromatic dispersion compensator according to claim 3, further comprising an excitation light reflection unit in the vicinity of the one end of the light waveguide.

5. The chromatic dispersion compensator according to claim 1, wherein the chromatic dispersion compensation unit includes a compensation amount adjuster for changing a chromatic dispersion compensation amount by varying a pitch of the grating.

6. The chromatic dispersion compensation unit according to claim 5, wherein the compensation amount adjuster changes the pitch of the grating by adjusting a temperature of the grating unit.

7. The chromatic dispersion compensation unit according to claim 1, wherein the light waveguide is an optical fiber having a core diameter smaller than a core diameter of a single mode fiber, the core of the optical fiber is doped with a rare earth ion, and the grating unit has the grating formed by a pitch of target wavelength of the signal light, the target wavelength being compensated, along at least a part of the longitudinal direction of the core of the optical fiber.

8. The chromatic dispersion compensation unit according to claim 1, wherein the light waveguide is an optical waveguide doped with a rare earth ion, and the grating unit has the grating formed by a pitch of a target wavelength of the signal light, the target wavelength being compensated, along at least a part of the longitudinal direction of the optical waveguide.

9. The chromatic dispersion compensation unit according to claim 1, wherein the light waveguide is doped with the rare earth ion at equal to or larger than 1,000 ppm.

10. The chromatic dispersion compensation unit according to claim 1, further comprising a controller for controlling power supplied from the light excitation source to the light waveguide so as to maintain a level of the power to a predetermined constant level.

11. The chromatic dispersion compensation unit according to claim 1, wherein the optical circulator includes four or more ports, a second port next to the port optically coupled to the input port is optically coupled to the chromatic dispersion compensation unit, a third port of the ports except the second port and a port optically coupled to the output port is a light waveguide for compensating a chromatic dispersion of a signal light using a grating.

12. The chromatic dispersion compensation unit according to claim 11, wherein the light waveguide optically coupled to the third port is doped with rare earth ion.

13. A light receiving apparatus for receiving each signal light optically divided from a wavelength multiplexed wave propagated through a transmission line, comprising:
a chromatic dispersion compensator including:
an optical circulator optically coupled to an input port and an output port;
a chromatic dispersion compensation unit including:
a light waveguide doped with the rare earth ion;
a grating unit including a grating formed in at least a part of the longitudinal direction of the light waveguide, the grating unit performing a chromatic dispersion compensation for a signal light input via the optical circulator to an one end of the light waveguide through the input port by reflecting the signal light flowing through the light waveguide according to a wavelength of the signal light and by returning the reflected signal light to the one end to lead to the output port via the optical circulator; and
a light excitation source for supplying, to the light waveguide, excitation light capable of exciting a rare earth ion, wherein each of the chromatic dispersion compensators is located on each light waveguide through which the signal light of a single wave length after optically divided.

14. A light relay apparatus located on a transmission line for transmitting a wavelength multiplexed wave comprising:
a chromatic dispersion compensator including:
an optical circulator optically coupled to an input port and an output port;
a chromatic dispersion compensation unit including:
a light waveguide doped with a rare earth ion;
a grating unit including a grating formed in at least a part of the longitudinal direction of the light waveguide, the grating unit performing a chromatic dispersion compensation for a signal light input via the optical circulator to an one end of the light waveguide through the input port by reflecting the signal light flowing through the light waveguide according to a wavelength of the signal light and by returning the reflected signal light to the one end to lead to the output port via the optical circulator; and
a light excitation source for supplying, to the light waveguide, excitation light,
wherein the chromatic dispersion compensator is arranged between wavelength multiplexed optical amplifiers in a former and later stages.
